(19) United States
(12) Patent Application Publication
(10) Pub. No.: US 2025/0242710 A1
(43) Pub. Date: Jul. 31, 2025

(54) VEHICLE RECHARGE MATCHING SYSTEMS AND METHODS

(71) Applicant: Toyota Motor Engineering & Manufacturing North America, Inc., Plano, TX (US)

(72) Inventors: Timothy Wang, Ann Arbor, MI (US); Roger Akira Kyle, Aubrey, TX (US); Bryan Else Yamasaki, Aubrey, TX (US); Justin K. Shen, Canton, MI (US); Jackson Zhu, Ann Arbor, MI (US); Xiao Xu, Novi, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/425,778

(22) Filed: Jan. 29, 2024

(51) Int. Cl. B60L 53/66

(52) U.S. Cl. CPC B60L 53/665; B60L 2240/622; B60L 2250/12; B60L 2250/16

(57) ABSTRACT

A method of vehicle recharge matching includes establishing a data connection between a vehicle electronic control unit and a charging station upon detection of a physical coupling of a charge cable to a vehicle. Upon receiving an indication that the charge cable has been physically disconnected from the vehicle and subsequently reconnected, the method further includes deactivating a supply of power to the charge cable and/or transmitting a verification request.

### TECHNICAL FIELD

The present disclosure generally relates to electric vehicle charging and, more specifically, to electric vehicle charging verification systems.

### BACKGROUND

Charging stations may include numerous electric supply units, at which drivers may pay to charge electric vehicles. Electric vehicles may require hours to fully charge, even when utilizing high-speed chargers. As such, an individual may leave the charging station while the electric vehicle is charging. However, leaving the electric vehicle unattended may result in theft of power running from the electric supply unit, as another individual may unplug the electric supply unit from a charging electric car and plug the electric supply unit into a different electric car. Existing locks for electric supply units may be difficult to implement, may be removed, may be circumvented, and/or the like.

### SUMMARY

In one aspect, a method of vehicle recharge matching includes establishing a data connection between a vehicle electronic control unit and a charging station upon detection of a physical coupling of a charge cable to a vehicle. Upon receiving an indication that the charge cable has been physically disconnected from the vehicle and subsequently reconnected, the method further includes deactivating a supply of power to the charge cable and/or transmitting a verification request.

In another aspect, an electric vehicle charging station includes a charging unit and a charge cable electrically coupled to the charging unit and configured to deliver an electrical current from the charging unit to a vehicle when physically coupled to the vehicle. The electric vehicle charging station also includes a charging station electronic control unit configured to communicatively couple to a vehicle electronic control unit when the charge cable is physically coupled to the vehicle. Upon receiving a signal indicating that the charge cable has been physically connected to the vehicle, the charging station electronic control unit is configured to establish a data connection between the vehicle electronic control unit and the charging station electronic control unit. Upon receiving an indication that the charge cable has been physically disconnected from the vehicle and subsequently reconnected, the charging station electronic control unit also deactivates a supply of power to the charge cable and/or transmits a verification request.

These and additional objects and advantages provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a charging station according to one or more embodiments shown and described herein;

FIG. 2 schematically depicts charging station map according to one or more embodiments shown and described herein; and

FIG. 3 schematically depicts a flow diagram of an illustrative method for vehicle recharge matching according to one or more embodiments shown and described herein.

### DETAILED DESCRIPTION

The systems and methods described herein generally relate to vehicle recharge matching including various features that assist in matching an electronic control unit of a vehicle with a charging station to prevent theft of power running from a charge cable into the vehicle. The features of the systems and methods described herein that prevent theft of power running from a charge cable generally function by establishing a data connection between the vehicle electronic control unit and the charging station and deactivating the charging unit and/or transmitting a verification request upon an indication that the charge cable has been physically disconnected from the vehicle and subsequently reconnected. Such data connections may generally be separate and distinct from data connections that may be used in conventional charging systems for monitoring a state of charge (SOC) between the vehicle and the charging station.

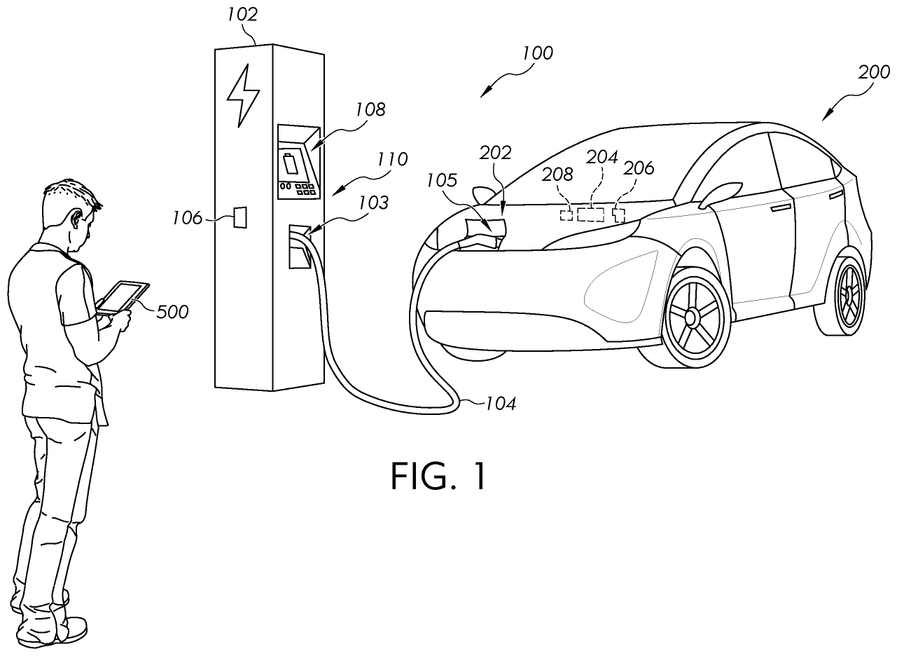

Referring now to FIG. 1, an electric vehicle charging station 100 is illustrated. The electric vehicle charging station 100 includes a charging unit 102 and a charge cable 104 electrically coupled to the charging unit 102 and configured to deliver an electric current from the charging unit 102 to a vehicle 200 when the charge cable 104 is physically coupled to the vehicle 200 (as depicted in FIG. 1). The charging station 100 also incudes a charging station electronic control unit 106 configured to communicatively couple to a vehicle electronic control unit 206 when the charge cable 104 is physically coupled to the vehicle 200. Upon receiving a signal indicating that the charge cable 104 has been physically connected to the vehicle 200, the charging station electronic control unit 106 may be configured to establish a data connection between the vehicle electronic control unit 206 and the charging station electronic control unit 106. Further, upon receiving an indication that the charge cable 104 has been physically disconnected from the vehicle 200 and subsequently reconnected (such as to a different vehicle), the charging station electronic control unit 106 may deactivate a supply of power to the charge cable 104 and/or transmit a verification request.

The charging station 100 may include one charging unit 102 or a plurality of charging units 102, such as to charge multiple vehicles 200. In addition, each charging unit 102 may include one or more charge cables 104. The charge cable 104 may have any type of connector thereon for coupling to the vehicle 200, such as, for example, a Type 1 connector, Type 2 connector, a combined charging system (CCS) connector, a Charge de Move (CHAdeMO) connector, a North American Charging Standard (NACS) connector, or any other charge cable and associated connector suitable for connection with the vehicle 200. The charging unit 102 may include a docking handle 103 to retain the charge cable 104 when the charge cable 104 is not connected to the vehicle 200.

The vehicle 200 may be an electric vehicle (EV) or any plug in hybrid electric vehicle (PHEV) that includes a battery capable of charging, such as with the charging unit 102 through the charge cable 104. The vehicle 200 may further include a vehicle head unit 204, which may be communicatively coupled to the vehicle electronic control unit 206. The vehicle head unit 204 may be any display device within the vehicle 200 that a user may view information and/or enter information into the vehicle head unit 204.

The charging unit 102 may include the charge cable 104, which may deliver alternating current or direct current to the vehicle 200 when physically coupled to a charge port 202 of the vehicle 200. The charge cable 104 may deliver the electric current to the vehicle 200 at a rate of up to about 5 kilowatts (kW), up to about 10 kW, up to about 20 kW, up to about 50 kW, up to about 100 kW, up to about 200 kW,, up to about 350 KW, up to about 400 kW, or any other suitable rate.

The charging station 100 and/or charging unit 102 may further include a charging station display 108, which may display information to the user (discussed further below). The charging station 100 and/or charging unit 102 may further include a payment reader 110 (e.g., a credit card reader). The payment reader 110 may be a contactless payment reader, a magstripe payment reader, a chip payment reader, or any other suitable payment reader that can capture payment (e.g., credit card, mobile pay, etc.) information of the user for payment of the power transferred from the charging unit 102 to the vehicle 200. The charging unit 102 may also include the charging station electronic control unit 106.

The charging station electronic control unit 106 may be communicatively coupled to the vehicle electronic control unit 206, such as through a communication path that communicatively couples various components of the charging station 100 and the vehicle 200. As used herein, the phrase “communicatively connected” or “communicatively coupled” means that coupled components are capable of exchanging data signals with one another such as, e.g., electrical signals via a conductive medium, electromagnetic signals via air, optical signals via optical waveguides, and the like.

Accordingly, the communication path may be formed from any medium that is capable of transmitting a signal such as, e.g., conductive wires, conductive traces, optical waveguides, and the like. In some embodiments, the communication path may facilitate the transmission of wireless signals, such as Wi-Fi, Bluetooth®, Near-Field Communication (NFC), and the like. Moreover, the communication path may be formed from a combination of mediums capable of transmitting signals. In one embodiment, the communication path comprises a combination of conductive traces, conductive wires, connectors, and buses that cooperate to permit the transmission of electrical data signals to components such as processors, memories, sensors, input devices, output devices, and communication devices. Accordingly, the communication path may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

Referring still to FIG. 1, the charge cable 104 may be physically connected to the vehicle 200 to charge the vehicle 200. The charge cable 104 may be connected to the vehicle 200 through the charge port 202 of the vehicle 200. The charge cable 104 may further include a connection sensor 105. The connection sensor 105 may be communicatively coupled to the charging station electronic control unit 106. As such, the connection sensor 105 may send a signal to the charging station electronic control unit 106 indicating that the charge cable 104 has been physically connected to the charge port 202 of the vehicle 200. Moreover, the connection sensor 105 may also send a signal to the charging station electronic control unit 106 that the charge cable 104 has been physically disconnected from the vehicle 200. The connection sensor 105 may be a magnetic proximity sensor, a photoelectric sensor, or any other suitable sensor for detecting connection of the charge cable 104 to the charge port 202 of the vehicle 200. The charging station electronic control unit 106 may perform various functions based on whether the charge cable 104 is physically connected to or physically disconnected from the vehicle 200, as described in greater detail herein.

Upon receiving a signal indicating that the charge cable 104 has been physically connected to the vehicle 200, the charging station electronic control unit 106 may establish a data connection between the vehicle electronic control unit 206 and the charging station electronic control unit 106. As noted hereinabove, the data connection may be through the communication path, which may be through the charge cable 104 or through a wireless connection. Such data connections may generally be separate and distinct from data connections that may be used in conventional charging systems for monitoring a state of charge (SOC) between the vehicle 200 and the charging station 100. In embodiments, the data connection may be incorporated with and include the data connections used in conventional charging systems for monitoring the SOC between the vehicle 200 and the charging station 100.

Once the data connection is established, the charging station electronic control unit 106 may transmit data from the vehicle electronic control unit 206 to the charging station electronic control unit 106 via the communication path. The data may include unique identifiers of the vehicle 200 and/or the user/driver of the vehicle. For example, the data transferred from the vehicle electronic control unit 206 may include credit card information of the user. In other embodiments, the data transferred from the vehicle electronic control unit 206 may include a user home address, a vehicle identification number (VIN), a vehicle license plate number, or any other identifier unique to the vehicle 200 and/or the user, such as to be later verified upon physical disconnection and reconnection of the charge cable 104.

Upon receiving an indication that the charge cable 104 has been physically disconnected from the vehicle 200 and subsequently reconnected, the charging station electronic control unit 106 may deactivate the supply of power to the charge cable 104, such as to prevent theft of the electric current running from the charge cable 104 to a vehicle other than the vehicle 200 of the user that paid for the supply of power. The charging station electronic control unit 106 may further transmit a verification request in response to the charge cable 104 being physically disconnected from the vehicle 200 and subsequently reconnected.

The verification request may be transmitted to various devices. In embodiments, the verification request may be transmitted to a user device 500, to the charging station display 108, to the vehicle head unit 204, or any other suitable device capable of receiving the verification request. The verification request may include a notification that the charge cable 104 has been physically disconnected from the vehicle 200 and subsequently reconnected. Upon receiving the verification request, the user may return to the vehicle 200 and ensure that the charge cable 104 is attached to the vehicle 200 of the user (i.e., the vehicle 200 that the user plugged the charge cable 104 into), rather than a different vehicle.

To continue the supply of power to the charge cable 104, the user may complete the verification request. The verification request may include a credit card verification request, such that the verification request requires the user to enter credit card information on the device that the verification request was transmitted to. The verification request may also include providing an instruction to insert, swipe, or tap a credit card at the credit card reader 110 of the charging station 100. In embodiments, the verification request may also be completed through completion of a push notification sent to the user device 500, through verifying biometrics such as fingerprint or facial recognition, or any other suitable verification method.

If the user determines that the charge cable 104 has been connected to a vehicle other than the user's vehicle 200, the user may deny the verification request, at which point the supply of power to the charge cable 104 may be deactivated until new payment information is entered at the charging station 100. When new payment information is entered into the charging station 100, the system may reset and connect to a different vehicle.

In addition, once the vehicle 200 is finished charging, the user may remove the charge cable 104 from the vehicle 200 and place the charge cable 104 back into the docking handle 103 so that the charge cable 104 may be subsequently used by another vehicle. Once the charge cable 104 is placed back into the docking handle 103 of the charging station 100, a second data connection between a second vehicle electronic control unit and the charging station 100 may be established upon detection of physical coupling of the charge cable 104 to a second vehicle. This may be repeated for any subsequent number of vehicles/charging sessions, so that each vehicle connected to the charge cable 104 after the charge cable 104 is placed into the docking handle 103 may establish the data connection with the charging station 100.

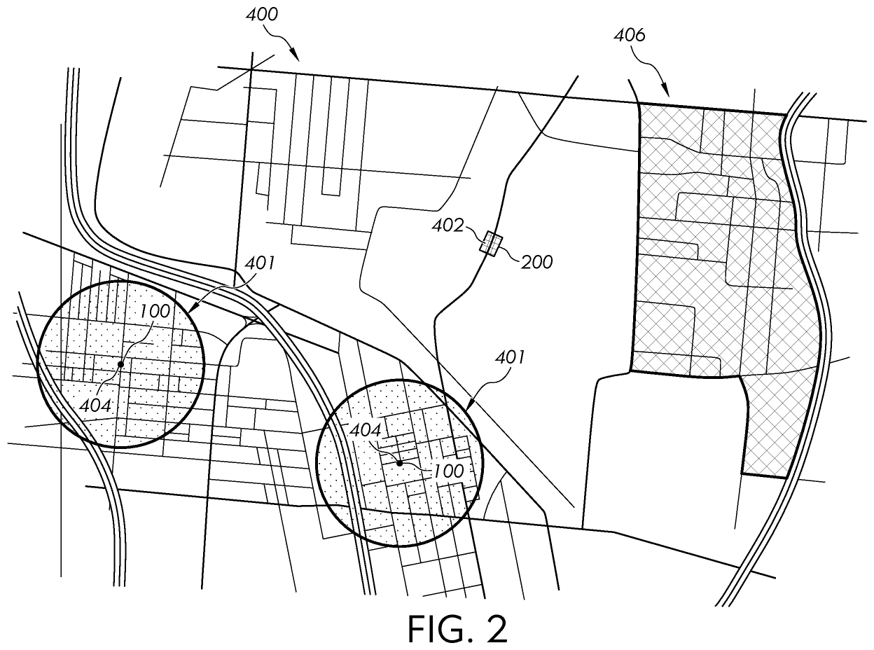

The charging station electronic control unit 106 may automatically determine the specific vehicle the charge cable 104 has been physically connected to through the data transmission from the vehicle electronic control unit 206. As such, if the charging station electronic control unit 106 determines that the charge cable 104 has been physically disconnected from the vehicle 200 but subsequently reconnected to the same vehicle 200, then the charging station electronic control unit 106 may forego deactivation of the supply of power to the charge cable 104 or transmission of the verification request, as there would be no issue with the charging station 100 supplying power to the incorrect vehicle. In some embodiments, the supply of power may be deactivated and the verification request may be transmitted regardless of whether the charge cable 104 is reconnected to the same vehicle 200 or a different vehicle. Whether the verification request is sent may also depend on a vehicle location 402 relative to a charging station location 404, as depicted in FIG. 2 and described below.

Referring now to FIG. 2, an exemplary map 400 depicting the vehicle location 402 and charging station location 404 is depicted. In embodiments, when the vehicle 200 is out of a threshold distance 401 from the charging station location 404, the verification request may be disabled, such that he verification request is no longer sent to the device. The verification request may also be disabled when it is determined that the vehicle location 402 is within a residential area 406. When the vehicle 200 is connected to a charge cable 104 while the vehicle location 402 is within a residential area 406, the vehicle 200 is likely at a home of the user and, thus, the verification request is disabled.

The vehicle location 402 may be determined through a GPS device. In embodiments, the vehicle 200 may include a proximity sensor 208 (as depicted in FIG. 1), such that the proximity sensor 208 may determine how close the vehicle 200 is to the charging station 100; the verification request may be disabled if the vehicle 200 is outside a threshold range from the charging station 100. The threshold range may be about 20 meters, about 50 meters, about 100 meters, about 1 kilometer, about 10 kilometers, or any other suitable distance from the charging station 100. The proximity sensor 208 may be an RFID sensor, a GPS device, or any device able to define or detect distances around the vehicle 200.

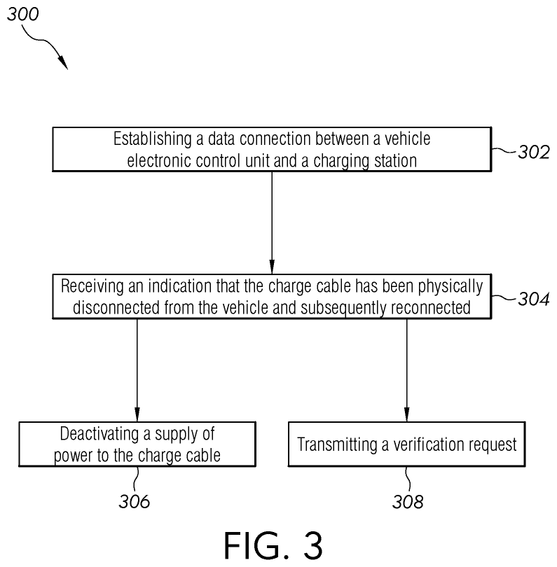

Referring now to FIG. 3, a flow diagram of an illustrative method 300 for vehicle recharge matching, using the electric vehicle charging station 100 and other components described herein, is depicted. In block 302, the method 300 may include establishing the data connection between the vehicle electronic control unit 206 and the charging station 100 (such as to the charging station electronic control unit 106). Block 304 may include receiving an indication that the charge cable 104 has been physically disconnected from the vehicle 200 and subsequently reconnected.

Upon receiving an indication that the charge cable 104 has been physically disconnected from the vehicle 200 and subsequently reconnected, the method 300 may further include deactivating the supply of power to the charge cable 104 in block 306. Alternatively or additionally, the method may also include transmitting the verification request in block 308.

The method 300 may further include transmitting the notification to the user device 500 when the charge cable 104 has been physically disconnected from the vehicle 200 and subsequently reconnected. The method 300 may also include determining the vehicle location 402 and disabling the verification request when the vehicle location 402 is within the residential area 406. In embodiments, the method 300 may further include transmitting data (such as credit card information of the user) from the vehicle electronic control unit 206 to the charging station 100 over the data connection. Upon the charge cable 104 being placed back into the docking handle 103 of the charging station 100, the method 300 may also include resetting the data connection and establishing the second data connection between the second vehicle electronic control unit and the charging station upon detection of a physical coupling of the charge cable 104 to the second vehicle.

It should now be understood that the embodiments disclosed herein include vehicle recharge matching systems. The vehicle recharge matching systems may deactivate a supply of power and transmit a verification request to a user when the a charge cable has been physically disconnected from a vehicle and subsequently reconnected. The user may complete the verification request to continue the supply of power from the charging station.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A method of vehicle recharge matching, the method comprising:
establishing a data connection between a vehicle electronic control unit and a charging station upon detection of a physical coupling of a charge cable to a vehicle; and
upon receiving an indication that the charge cable has been physically disconnected from the vehicle and subsequently reconnected:
deactivating a supply of power to the charge cable; and/or
transmitting a verification request.

2. The method of claim 1, wherein the verification request is transmitted to a user device and/or a charging station display.

3. The method of claim 1, further comprising transmitting a notification to a user device when the charge cable has been physically disconnected from the vehicle and subsequently reconnected.

4. The method of claim 1, wherein the verification request is a credit card verification request.

5. The method of claim 4, wherein the verification request comprises providing an instruction to insert, swipe, or tap a credit card at a payment reader of the charging station.

6. The method of claim 1, further comprising:
determining a vehicle location; and
when the vehicle location is within a residential area, disabling the verification request.

7. The method of claim 1, further comprising transmitting data from the vehicle electronic control unit to the charging station over the data connection, wherein the data from the vehicle electronic control unit includes credit card information of a user.

8. The method of claim 1, wherein upon the charge cable being placed back into a docking handle of the charging station, resetting the data connection and establishing a second data connection between a second vehicle electronic control unit and the charging station upon detection of a physical coupling of the charge cable to a second vehicle.

9. A electric vehicle charging station, the charging station comprising:
a charging unit;
a charge cable electrically coupled to the charging unit and configured to deliver an electrical current from the charging unit to a vehicle when physically coupled to the vehicle; and
a charging station electronic control unit configured to communicatively couple to a vehicle electronic control unit when the charge cable is physically coupled to the vehicle, wherein, upon receiving a signal indicating that the charge cable has been physically connected to the vehicle, the charging station electronic control unit is configured to:
establish a data connection between the vehicle electronic control unit and the charging station electronic control unit; and
upon receiving an indication that the charge cable has been physically disconnected from the vehicle and subsequently reconnected:
deactivate a supply of power to the charge cable; and/or
transmit a verification request.

10. The electrical vehicle charging station of claim 9, wherein the verification request is transmitted to a user device and/or a charging station display.
